(19) United States
(12) Patent Application Publication
(10) Pub. No.: US 2013/0098904 A1
(43) Pub. Date: Apr. 25, 2013

(54) HEATING SYSTEM UTILIZING MICROWAVE

(71) Applicants: Akikazu HARADA, Saitama-ken (JP); Kiichi KANDA, Kanagawa-ken (JP); Ken-ichi WATANABE, Kanagawa-ken (JP); Natsumi SAKAMOTO, Kanagawa-ken (JP); Shin-ichi TAKAHASHI, Kanagawa-ken (JP)

(72) Inventors: Akikazu HARADA, Saitama-ken (JP); Kiichi KANDA, Kanagawa-ken (JP); Ken-ichi WATANABE, Kanagawa-ken (JP); Natsumi SAKAMOTO, Kanagawa-ken (JP); Shin-ichi TAKAHASHI, Kanagawa-ken (JP)

(73) Assignees: KANTO YAKIN KOGYO CO., LTD., Kanagawa-ken (JP); MIKURO DENSHI CO., LTD., Saitama-ken (JP)

(21) Appl. No.: 13/495,796

(22) Filed: Jun. 13, 2012

(30) Foreign Application Priority Data
Jun. 20, 2011 (JP) 2011-136276

(51) Int. Cl. H05B 6/64

(52) U.S. Cl. 219/756

(57) ABSTRACT

This present invention provides a heating system utilizing microwave energy for an improved manufacture of high quality fibers such as carbon fiber and graphitic fiber while simultaneously simplifying construction and meeting a demand for saving electric energy.

This application claims priority to JP application 2011-136276, filed on Jun. 20, 2011, which is herein incorporated by reference in its entirety.

### BACKGROUND OF THE INVENTION

This invention relates to a heating system utilizing microwave energy and particularly to the heating system suitable as a heating furnace used to manufacture, for embodiment, carbon fiber or graphitic fiber.

### Background Art

The carbon fiber is usually manufactured by the process including steps of heat-treating (flame-proofing) organic synthetic fibers such as polyacrylonitrile (PAN) in air at a temperature in a range of 200 to 300° C. with use of a flame-proofing furnace to produce string-like flame resistant fibers preliminarily and heat-treating the flame resistant fibers in inert atmosphere at a temperature in a range of 1000 to 1500° C. with use of a carbonizing furnace.

The carbon fiber manufactured in this manner is used as material for parts of car.

The aforementioned carbon fiber may be heat-treated in inert atmosphere at a temperature in a range of 2000 to 2500° C. with use of a graphitizing furnace to obtain graphitic fiber.

The graphitic fiber is used as material for parts of aircraft.

As the carbonizing furnace for manufacturing of the carbon fiber and the graphitizing furnace for manufacturing of the graphitic fiber, the electric heating system has widely been used.

FIG. 19 is a schematic diagram illustrating a cross-section of a principal part in the heating furnace of prior art and FIG. 20 is a scale-enlarged sectional view taken along a line A-A in FIG. 19.

As illustrated, this heating furnace 1 includes an oblong heating furnace main body 2, an inlet 3 and an outlet 4 of the heating furnace 1, a heating oven 5, supporting pedestals 6 for the heating oven 5, electric heaters 7 and heat insulating layers 8.

In this heating furnace 1, string-like works (organic synthetic fibers) 9 is introduced through the inlet 3 into the heating oven 5 and discharged through the outlet 4 to heat the works 9 at a predetermined high temperature followed by cooling the works 9 in a cooling system to produce the carbon fiber or the graphitic fiber.

The aforementioned heating oven 5 is made of material such as carbon having high heat conductivity and sufficiently withstanding a targeted high temperature in the form of a hollow body having a flat cross-section. Such heating oven 5 is supported by the supporting pedestals 6 made of heat insulating material so as to extend along straight line segment connecting the inlet 3 and the outlet 4 of the heating furnace main body 2, i.e., to extend in the transverse direction as viewed in FIG. 19.

A plurality of the electric heaters 7 are arranged above and below the heating oven 5 and these electric heaters 7 are turned on to generate heat of which radiation heat is used to heat the heating oven 5 and thereby to elevate the temperature of the heating oven 5.

As illustrated in FIG. 20, each of the electric heaters 7 includes a rod-like electrical resistance heating element 7a, conductive heating element terminals 7b and electrodes 7c. More specifically, the heating element terminals 7b are attached to the heating furnace main body 2 by the intermediary of electric insulating material and the electrodes 7c are clamped to these heating element terminals 7b so that the respective electric heaters 7 may extend in the direction crossing the direction in which the works 9 are transported.

The electric heaters 7 constructed in this manner are supplied with power from the commercial power source via the respective electrodes 7c and thereby the electrical resistance heating elements 7a are applied with alternating current to generate heat.

In this way, a heating temperature of the heating oven 5 is elevated by heat generation of the electrical resistance heating elements 7a to a target temperature required for the heating oven 5 to achieve appropriate heat treatment of the works 9 primarily the radiation heat from the heating oven 5.

In this regard, it is well known that the electrical resistance heating elements 7a generate heat due to Joule dissipation. The heat energy radiated from the electrical resistance heating elements 7a is proportional with the fourth power of the temperature of the electrical resistance heating elements 7a and inversely proportional with the second power of a distance. In other words, higher the temperature, the radiation heat increases.

For manufacturing of the carbon fiber, in addition to the above-described heating furnace of the electric heater type, a heating furnace utilizing microwave power has been proposed, for example, by JP Patent Publication No. 62-7288.

This heating furnace of prior art includes a furnace body, a conveying device (belt conveyor) running within the furnace, a microwave radiating device adapted to radiate the microwave within the furnace and an inert gas flowing device. In addition, a temperature control device and a cooling device are provided in association with the aforementioned constituents.

In this heating furnace, a container containing raw fibers is loaded on the conveyor belt and transported through the furnace so as to the raw fibers are irradiated with the microwave.

The raw fibers heated by irradiation of the microwave in this manner and discharged through the outlet in the form of the carbon fiber are then cooled by the cooling device.

When it is desired, with use of this heating furnace, to obtain the carbon fiber from coal-based pitch fiber treated to be infusible, raw fibers having length of about 1 m are bundled in the form of a tow and these tows are stacked one on another to a thickness of 100 mm and filled up in the container a filling density of 50 kg/m³.

A plurality of such containers may be prepared and successively fed into the furnace to obtain the carbon fiber.

In the case of the aforementioned heating furnace of the electric heater type, the temperature of the electrodes 7c in the respective electric heaters 7 are necessarily elevated to the unacceptable level and it is essential to cool the electrodes 7c by liquid such as water and thereby to maintain the temperature thereof lower than a critical temperature.

This is for the reason that the electrodes 7c are made of good conductor, for example, copper material and high temperature of the electrical resistance heating elements 7a is inevitably propagated via the heating element terminals 7b to the electrodes 7c and unacceptably elevates the temperature of the electrodes 7c. Cooling the electrodes 7c with use of liquid such as water is the countermeasure to prevent the electrodes made of copper material or the like from being molten.

Consequently, in the case of the heating furnace of this type, the portion of the thermal dose which is cooled at the respective electrodes 7c by liquid such as water is consumed in vain and this thermal dose consumed in vain corresponds to 30% or more of total power supplied to the electric heaters 7.

Furthermore, in the heating furnace of the electric heater type, heat energy provided from the electric heaters 7 cannot heat the heating oven 5 to elevate the temperature thereof in a focused way. Specifically, the portion of the heat energy which can contribute to heat the heating oven is limited to a range defined by a solid angle covering the heating oven and the rest is the loss of the heat energy. For example, the rest of the heat energy is consumed to heat the surface of the heat insulating layer 8. The heat energy radiated to the constituents such as the heat insulating layer 8 corresponds to 50% or more of the total energy from the electric heaters 7 and such remarkably high percentage of the heat energy is consumed in vain.

Moreover, in the case of the heating furnace of the electric heater type, a time period required for starting up the heating furnace to wait until the heating furnace main body 2 attains to the thermal equilibrium state, in other words, until the temperature is stabilized and the works can be stably heat treated is considerably long. In consequence, the amount of electric energy consumed in vain for starting up the heating furnace is correspondingly increased.

Even in the carbon fiber manufacturing furnace of the electric heater type taking the electric power saving into account, the energy actually contributing to heat-treatment of the works is reported to be, in general, only about 45% of the total input electric energy.

Meanwhile, the conventional heating furnace utilizing the microwave is basically designed so that the container filled with raw fibers at high filling density may be transported within the furnace and the raw fibers may be irradiated with the microwave to produce the carbon fiber. For such conventional heating furnace, when the individual raw fibers, for example, 12,000 raw fibers arranged side by side in the transverse direction without use of the container are transported through the furnace, a filling density will be too low to heat the raw fibers within the heating furnace effectively.

Considering such existing situation, this invention aims to propose a heating system utilizing the microwave improved to manufacture the high quality fibers such as carbon fiber and graphitic fiber with a simplified construction and simultaneously to meet a demand for saving of the electric energy.

### SUMMARY OF THE INVENTION

To achieve the object set forth above, this invention on a first aspect thereof proposes a heating system with use of microwave characterized in that the system includes a heating furnace main body made of metallic material, microwave supplying means adapted to supply the heating furnace main body with microwave power, filtering zones respectively provided in the vicinity of an inlet at one side of the heating furnace main body and in the vicinity of an outlet at the other side of the heating furnace main body to prevent leak of the microwave power a heating oven formed of microwave heat generating material in a form of an oblong hollow body so as to extend linearly between the inlet and the outlet of the heating furnace main body; and heat insulator having low microwave absorption ability adapted to separate off a space defined between an inner surface of the heating furnace main body and an outer surface of the heating oven from a space within the heating oven and adapted also to hold the heating oven, wherein a work or works is or are supplied through the into the heating oven and discharged from the outlet to heat the work or works within the heating oven.

This invention on a second aspect thereof proposes a heating system with use of microwave characterized in that the system includes a heating furnace main body made of metallic material, microwave supplying means adapted to supply the heating furnace main body with microwave power, filtering zones respectively provided in the vicinity of an inlet at one side of the heating furnace main body and in the vicinity of an outlet at the other side of the heating furnace main body to prevent leak of the microwave power, a heating oven formed of microwave heat generating material in a form of an oblong hollow body so as to extend linearly between the inlet and the outlet of the heating furnace main body and heat insulator having low microwave absorption ability adapted to hold the heating oven, wherein a work or works is or are supplied into the heating oven and discharged from the outlet to heat the work or works within the heating oven.

This invention on a third aspect thereof proposes the heating system with use of microwave according to one of the first and second aspects of the invention, characterized in that the outer surface of the heating oven is partially or wholly covered with insulating material having low microwave absorption ability.

This invention on a fourth aspect thereof proposes the heating system with use of microwave according to any one of the first through third aspects of the invention, characterized in that the inner surface of the heating furnace main body is partially or wholly covered with insulating material.

This invention on a fifth aspect thereof proposes the heating system with use of microwave according any one of the first through fourth aspects of the invention, characterized in that the heating oven made of microwave heat generating material

This invention on a sixth aspect thereof proposes the heating system with use of microwave according to any one of the first through defined by any one of the first through fifth aspects, characterized in that the heating oven has its inner surface formed of microwave shielding material and its outer surface formed of microwave heat generating layer intermittently arranged in an axial direction of the heating oven.

The invention on a seventh aspect thereof proposes the heating system with use of microwave according to any one of the first through sixth aspects of the invention, characterized in that the heating oven is of three-layered construction including an inner layer made of microwave shielding material, an intermediate layer made of microwave heat generating material and an outer layer made of low microwave absorption ability.

The invention on a eighth aspect thereof proposes the heating system with use of microwave according to any one of the first through seventh aspects of the invention, characterized in that the heating oven is provided in a form of an oblong hollow body having a rectangular cross-sectional shape and portions of the heating oven corresponding to upper and lower sides of the aforementioned rectangular cross-section are respectively of three-layered construction including the inner layer formed of microwave shielding material, the intermediate layer formed of microwave heat generating material and the outer layer formed of heat insulating material having low microwave absorption ability, on one hand, and portions of the heating oven corresponding to right and left sides of the rectangular cross-section are respectively of two-layered construction including the outer layer formed of heat insulating material having low microwave absorption ability, on the other hand.

This invention on a ninth aspect thereof proposes the heating system with use of microwave according to any one of the first through eighth aspects of the invention, characterized in that the filtering zones are respectively provided with microwave heat generating means.

Even in the carbon fiber manufacturing furnace of the electric heater type taking the electric power saving into account, the energy actually contributing to heat-treatment of the works is reported to be, in general, only about 45% of the total input electric energy.

Meanwhile, the conventional heating furnace utilizing the microwave is basically designed so that the container filled with raw fibers at high filling density may be transported within the furnace and the raw fibers may be irradiated with the microwave to produce the carbon fiber. For such conventional heating furnace, when the individual raw fibers, for example, 12,000 raw fibers arranged side by side in the transverse direction without use of the container are transported through the furnace, a filling density will be too low to heat the raw fibers within the heating furnace effectively.

Considering such existing situation, this invention aims to propose a heating system utilizing the microwave improved to manufacture the high quality fibers such as carbon fiber and graphitic fiber with a simplified construction and simultaneously to meet a demand for saving of the electric energy.

The aforementioned heating system according to the first aspect of the invention is characterized in that the heating oven can be heated in a focused way to elevate a temperature thereof.

In this regard, the heating oven may be formed of the microwave heat generating material such as ceramics, zirconia or silicon carbide mixed with powder of carbon or graphite or carbon nanotube.

The heating furnaces main body of the heating system is preferably formed of nonmagnetic metallic material.

This is for the reason that the microwave can penetrate the nonmagnetic metallic material to a depth as slight as several microns and heat generation (loss) corresponding only to Joule loss is also insignificant. In consequence, the nonmagnetic metallic material is not heated to a significantly high temperature due to the microwave power.

The microwave power almost free from being consumed as Joule loss is reflected on the heating furnace main body formed of the nonmagnetic metallic material.

If the heating furnace main body is formed of magnetic metallic material, the surface thereof will be heated due to Joule loss and hysteresis loss and the microwave power correspondingly decreases. Consequentially, a heating efficiency of the heating oven will be lowered. However, it is not impossible to use in practice the heating furnace main body formed of the magnetic metallic material so far as this problem is previously taken into account.

The heat insulator serving to separate off the space defined between the inner surface of the heating furnace main body and the outer surface of the heating oven from the space within the heating oven is formed of material having low microwave power absorption ability.

This heat insulator may be formed of material containing a primary ingredient such as alumina, silica, mullite or magnesia which allows permeation of the microwave.

Combination of the heating furnace main body formed of the nonmagnetic metallic material with the heating oven separated off and insulated from the heating furnace main body by the heat insulator allows the heating oven to be heated so as to elevate the temperature thereof in a focused way.

Consequently, it is possible to obtain the heating system which is low in power consumption, simple in a structure adapted to make the works run through the heating oven and able to produce high quality carbon fiber or graphite fiber.

Particularly because the inner space of the heating oven functions as so-called isothermal wall adapted to be irradiated with uniform heat energy from its environment, it is possible to heat the works uniformly and to produce high quality carbon fiber or graphite fiber even when a plurality of works or a plurality of work bundles is introduced at once into the heating oven so as to pass therethrough.

In addition, because the inner space of the heating furnace main body and the inner space of the heating oven are separated off and isolated from each other by the heat insulator, smoke and gas generated when the works are heated within the heating oven can be exhausted through the inlet and the outlet of the heating furnace main body.

In consequence, there is almost no anxiety that the inner space of the heating oven might be contaminated with smoke and gas generated from the works and it is possible to obtain the heating system including the heating oven which can be heated to elevate its temperature stably even if the heating oven is used for a long period.

Meanwhile, the heat insulator separating off and insulating the inner space of the heating furnace main body and the inner space of the heating oven is substantially microwave permeable and absorbs substantially no microwave power. This means that the microwave power penetrates also into the heating oven.

Within the heat oven, however, an electromagnetic field distribution of the microwave is not uniform and, if a plurality of the works having high microwave absorption ability is introduced into the heating oven, the individual works will pass different microwave electromagnetic fields, i.e., regions of different heating conditions, respectively, and there is a possibility that the respective individual works might be subjected to uneven heating effect.

In general, if the microwave absorption ability of the works is 10% or more higher than the microwave absorption ability of the microwave heat generating material forming the heating oven, the works will be heated under the influence of the microwave power.

Particularly in the case of the works of which the microwave absorption ability is 50% or higher, in the course of passing through the heating oven, these works will be significantly affected by the uneven microwave electromagnetic field and correspondingly significant difference of heat treatment occurs among the respective works.

From the viewpoint of this problem, in the heating system according to this invention on the first aspect thereof, it is essential that the microwave absorption ability of the works should be 50% or less of the microwave absorption ability of the microwave heat generating material

However, with exception of special works, most substances have the microwave absorption ability 50% or less of the microwave absorption ability of the microwave heat generating material and it is possible for the heating system according to the first aspect of this invention to produce high quality carbon fiber or graphite fiber.

Among the works which are similar in that they have the dielectric loss factors, the dielectric loss factors are different one from another depending kinds and/or amount of ingredients contained therein.

From this viewpoint, it is required for the heating system according to the first aspect of this invention to determine a level of the dielectric loss factor. However, considerable labor is required for determination of the dielectric loss factor.

This problem is solved by the heating system according to the second aspect of this invention.

In the heating system according to the second aspect of the invention, the heating oven rectilinearly extends between the filtering zone provided at the inlet of the heating furnace main body and the filtering zone provided at the outlet of the heating furnace so that the opposite ends of the heating oven open outside the heating furnace main body and the microwave power cannot intrude into the heating oven.

In consequence, the works passing through the heating oven are not influenced by the microwave power whether the microwave absorption ability of these works are high or low and, in consequence, the works are evenly heat treated and discharged from the heating oven as the high quality products.

Furthermore, the outer surface of the heating oven may be partially or fully covered with the heat insulating material having low microwave absorption ability to decrease the heat energy escaping from the outer surface of the heating oven and thereby to save the heat energy more effectively.

As the heat insulating material covering the heating oven, the material containing, for example, alumina, silica, mullite or magnesia as a primary ingredient may be used.

In a similar fashion, as proposed by the fourth aspect of the invention, the inner surface of the heating furnace main body may be partially or fully covered with the heat insulating material to same the energy more efficiently.

The heat insulating material used to cover the inner surface of the heating furnace main body is subjected to a temperature sufficiently lower than a temperature to which the outer surface of the heat oven is subjected. On account of this, it is not essential to use the similar heat insulating material used to cover the heating oven which has low microwave absorption ability used to cover the heating oven. However, the heat insulating material containing alumina, silica, mullite or magnesia as the primary ingredient, i.e., the material having low microwave absorption ability even at a high temperature may be used to alleviate attenuation of the microwave power when the microwave power penetrates the heat insulating material further effectively.

In this way, both the outer surface of the heating oven and the inner surface of the heating furnace main body may be covered with the insulating material having low microwave absorption ability to improve the energy saving effect further efficiently.

Moreover, as proposed by the fifth aspect of the invention, the inner surface of the heating oven formed of the microwave heat generating material with the microwave shielding material to assure that the microwave power heats the microwave heat generating material and simultaneously penetrates this microwave heat generating material to the microwave shielding material and is reflected on this shielding material.

As a result, the microwave power does not penetrate into the tunnel of the heating oven.

Particularly, according to this invention, it is possible to save an amount used of the microwave heat generating material without considering a microwave's depth of penetration (depth for power reduction by half).

A following graphic diagram is a reference diagram of the depth for power reduction by half.

According to FIG. 21, for example, in the case of silicon carbide at a temperature of 25° C., a depth D for power reduction by half of the microwave power of 2.45 GHz is 5 cm.

In general, higher the temperature, the depth for power reduction by half is smaller.

For example, in the case of zirnonia, the depth for power reduction by half is about 2.5 cm at a temperature of 300° C., the depth for power reduction by half is about 1.9 cm at a temperature of 500° C. and the depth for power reduction by half is about 0.7 cm at a temperature of 800° C.

Meanwhile, the depth D of the microwave power penetrating the microwave heat generating material is obtained according to a following formula:

$$D = \frac{3.32 \times {10}^{7}}{f \sqrt{{ɛ}_{r}} \cdot tan δ}$$

wherein f represents a frequency, εr represents a relative permittivity and tanδ represents a dielectric loss angle.

In consequence, a power ratio of the microwave penetrating the microwave heat generating material from which the heating oven is formed is changes as following:

| | Microwave power (%) |
|---|---|
| Depth from the surface | further penetrating |
| 1 × D | 50.0% |
| 2 × D | 25.0% |
| 3 × D | 12.5% |
| 4 × D | 6.25% |
| 5 × D | 3.13% |
| 6 × D | 1.56% |
| 7 × D | 0.78% |
| 8 × D | 0.39% |

For example, on the assumption that the heating oven having a thickness of 5 cm is formed of zirconia as the microwave heat generating material, 25/0% of the microwave power will penetrate the tunnel of the heating oven at a temperature of 300° C., 16.14% of the microwave power will penetrate the tunnel of the heating oven at a temperature of 500° C. and 0.7% of the microwave power will penetrate the tunnel of the heating oven at a temperature of 800° according to a rough estimate.

So, it is suggested that, if the microwave heat generating material has a relatively small thickness and a temperature within the heating oven is relatively low, the microwave power of high intensity may penetrate the tunnel of the heating oven and leak out of the heating system along the tunnel.

In the case of the good conductor, a functional relationship is established between the electromagnetic field value on the surface and a depth of 1/e=0.368, i.e., skin depth δ:

$$δ = {( \frac{2}{ω μ σ} )}^{\frac{1}{2}}$$

wherein ω represents an angular frequency (ω=2πf: f represents a frequency), μ represents a magnetic permeability of the substance and σ represents an electric conductivity of the substance.

According to the above-mentioned formula, in the case of the microwave power of 2.45 GHz, a skin depth of copper is about 1.32 μm and a skin depth of carbon (graphite) is about 41.2 μm.

While the carbon is electrical resistance material and has a skin depth as large as about 31 times of that of copper, a carbon plate having a thickness of 0.5 mm can sufficiently shield the microwave power because an electromagnetic field intensity of the microwave power is restricted to about 1/185,700.

For example, the heating oven formed of zirconia as the microwave heat generating material may be merely provided on the inner surface thereof with carbon layer having a thickness of 0.5 mm to prevent the microwave power from leaking into the tunnel.

While carbon is the advantageous too be used as the microwave shielding material provided on the inner surface of the heating oven from the viewpoint of its cost and its low probability of damaging the works, the microwave shielding material is not limited to carbon but the good conductor such as metallic material also may be used as the shielding material so far as the microwave power is effectively reflected thereon.

In the case of the heating oven having the inner surface formed of the microwave shielding material and the outer surface formed of the microwave heat generating layers provided intermittently in the axial direction of the heating oven proposed by the invention on the sixth aspect thereof, the microwave shielding material is also the heat conducting material. In consequence, the heat energy generated in the microwave heat generating layers is diffusively propagated in the microwave shielding material and, when a steady state is established, a temperature distribution in the microwave shielding material becomes relatively uniform except the ends or the vicinity thereof of the heating oven.

It is possible, therefore, to locate the microwave heat generating layers in the zones in which the microwave power is intensely radiated.

The microwave heat generating partial layers may be prepared so that the respective layers may have optimal dimensions in the axial direction and these partial layers may be attached not continuously but intermittently to obtain the heating oven having desired characteristics.

The heating oven according to the seventh aspect of the invention is characterized in that the heating oven is of three-layered construction including an inner layer made of microwave shielding material, an intermediate layer made of microwave heat generating material and an outer layer made of low microwave absorption ability.

The eighth aspect of the invention is a variation of the seventh aspect of the invention and characterized in that the heating oven is provided in a form of an oblong hollow body having a rectangular cross-sectional shape and portions of the heating oven corresponding to upper and lower sides of the aforementioned rectangular cross-section are respectively of three-layered construction including the inner layer formed of microwave shielding material, the intermediate layer formed of microwave heat generating material and the outer layer formed of heat insulating material having low microwave absorption ability, on one hand, and portions of the heating oven corresponding to right and left sides of the rectangular cross-section are respectively of two-layered construction including the outer layer formed of heat insulating material having low microwave absorption ability, on the other hand.

As in the ninth aspect of the invention, the filtering zones may be respectively provided with microwave heat generating means to assure that the filtering effect is improved and simultaneously heat flow at the ends of the heating oven is also improved. In this way, the heating oven can be efficiently kept at the desired high temperature, leak of the microwave power potentially occurring at the inlet and the outlet of the heating furnace main body can be prevented and the energy saving effect is also improved.

### BRIEF DESCRIPTION OF THE DRAWINGS

FIG. 1 is a sectional view of heating system according to a first embodiment of this invention taken along a plane extending in parallel to a direction in which a work is transported.

FIG. 2 is a scale-enlarged sectional view taken along a line B-B in FIG. 1.

FIG. 3 is a sectional view similar to FIG. 1, illustrating a modified embodiment of the first embodiment wherein a heating furnace main body is provided on an inner surface thereof with thermal insulator.

FIG. 4 is a sectional view similar to FIG. 1, illustrating another modified embodiment of the first embodiment wherein a heating oven is provided on an outer surface thereof with a thermal insulator having low microwave absorption capability.

FIG. 5 is a sectional view similar to FIG. 1, illustrating still another modified embodiment of the first embodiment wherein the heating furnace main body is provided on the inner surface thereof with thermal insulator and the heating oven is provided on the outer surface thereof with thermal insulator having low microwave absorption capability.

FIG. 6 is a sectional view similar to FIG. 1, illustrating yet another modified embodiment of the first embodiment wherein the heating oven is of three-layered construction including an inner layer formed of microwave shielding material, an intermediate layer formed of microwave heat generating material and an outer layer formed of thermal insulator having low microwave absorption capability and the heating furnace main body is provided on the inner surface with thermal insulator.

FIG. 7 is a scale-enlarged sectional view taken along a line C-C in FIG. 6.

FIG. 8 is a sectional view similar to FIG. 1, illustrating further another modified embodiment of the first embodiment wherein the heating oven is of three-layered construction including the inner layer formed of microwave shielding material, the intermediate layer formed of intermittently provided microwave heat generating material and an outer layer formed of thermal insulator having low microwave absorption capability.

FIG. 9 is a sectional view similar to FIG. 1, illustrating still another modified embodiment of the first embodiment wherein the heating oven is of three-layered construction including the inner layer formed of microwave shielding material, the intermediate layer formed of intermittently provided microwave heat generating material and an outer layer formed of thermal insulator having low microwave absorption capability and the heating furnace main body is provided on the inner surface thereof with thermal insulator.

FIG. 10 is a sectional view of the heating system according to a second embodiment of this invention taken along the plane extending in parallel to the direction in which the work is transported.

FIG. 11 is a sectional view similar to FIG. 10 illustrating a modified embodiment of the second embodiment wherein a heating oven is provided on an outer surface thereof with thermal insulator having a low microwave absorption capability.

FIG. 12 is a sectional view similar to FIG. 10, illustrating another modified embodiment of the second embodiment wherein the heating oven is of three-layered construction including the inner layer formed of microwave shielding material, the intermediate layer formed of intermittently provided microwave heat generating material and an outer layer formed of thermal insulator having low microwave absorption capability.

FIG. 13 is a sectional view similar to FIG. 10, illustrating still another modified embodiment of the second embodiment wherein the heating oven is of three-layered construction including the inner layer formed of microwave shielding material, the intermediate layer formed of partially provided microwave heat generating material and an outer layer formed of thermal insulator having low microwave absorption capability.

FIG. 14 is a sectional view similar to FIG. 10, illustrating yet another modified embodiment of the second embodiment wherein the heating oven is of three-layered construction including the inner layer formed of microwave shielding material, the intermediate layer formed of intermittently provided microwave heat generating material and an outer layer formed of thermal insulator having low microwave absorption capability.

FIG. 15 is a sectional view similar to FIG. 10, illustrating further another modified embodiment of the second embodiment wherein a filtering zone is provided with microwave heat generating material functioning as microwave absorption material.

FIG. 16 is a sectional view similar to FIG. 15, illustrating a modified embodiment wherein the heating furnace main body is provided on the inner surface thereof with thermal insulator.

FIG. 17 is a sectional view similar to FIG. 7, illustrating a modified embodiment wherein the heating oven is of three-layered construction including the inner layer formed of microwave shielding material, the intermediate layer formed of microwave heat generating material and the outer layer formed of thermal insulator having a low microwave absorption capacity and wherein the heating oven has a transversely long rectangular cross-section.

FIG. 18 is a sectional view similar to FIG. 17, illustrating a modified embodiment of the heating oven wherein portions of the heating oven corresponding to upper and lower sides of the rectangular cross-section are respectively three-layered structures each including an inner layer formed of microwave shielding material, an intermediate layer formed of microwave heat generating material and an outer layer formed of thermal insulator and wherein portions of the heating oven corresponding to right and left sides of the rectangular cross-section are respectively two-layered structures each including an inner layer formed of microwave shielding material and an outer layer formed of thermal insulator.

FIG. 19 is a sectional view exemplarily illustrating the heating furnace of prior art.

FIG. 20 is a scale-enlarged sectional view taken along a line A-A.

FIG. 21 is a chart of the dielectric loss angle.

### DESCRIPTION OF THE PREFERRED EMBODIMENTS

Details of this invention will be fully understood from the description given hereunder on the basis of preferred embodiments of this invention in reference to the accompanying drawings.

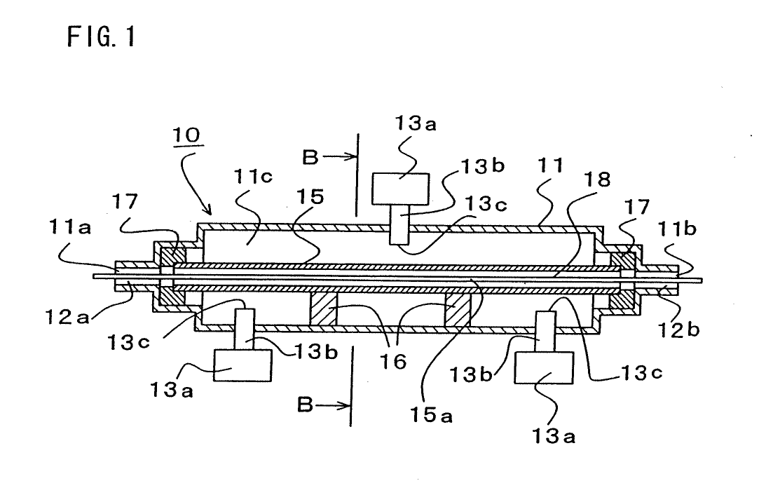

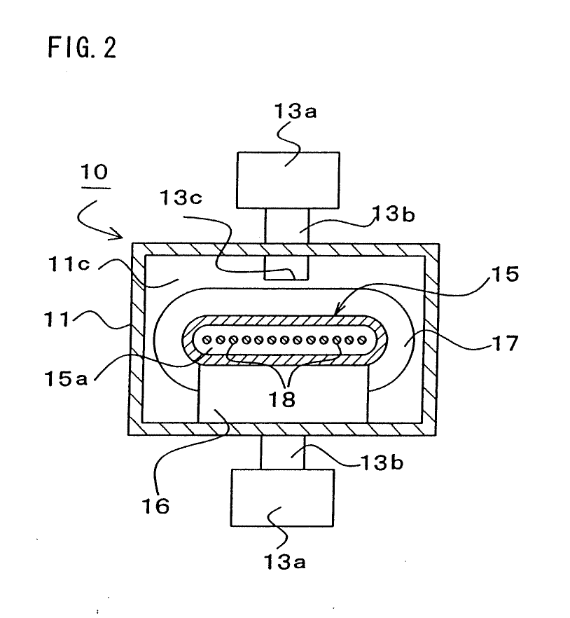

FIG. 1 is a sectional view of heating system according to a first embodiment of this invention taken along a plane extending in parallel to a direction in which a work is transported and FIG. 2 is a scale-enlarged sectional view taken along a line B-B in FIG. 1.

As will be apparent from FIGS. 1 and 2, the heating system 10 according to this embodiment includes a heat furnace main body 11 and a microwave supplying means adapted to supply microwave power into this heating furnace main body.

The heating furnace main body 11 is made of nonmagnetic metallic material in the form of a transversely long box and provided on one side in the longitudinal direction with an inlet 11a and on the opposite side with an outlet 11b.

In the vicinity of these inlet 11a and outlet 11b, filtering zones 12a, 12b are provided so as to prevent microwave power from leaking.

These filtering zones 12a, 12b utilize a choke structure to block passage of the microwave power and thereby to prevent the microwave power from leaking out of the heating furnace main body even when these filtering zones 12a, 12b are of noncontact type.

The microwave supplying means is of well known art and includes microwave oscillators 13a, waveguide circuits 13b and radiation windows 13c.

In this regard, while there are provided three microwave supplying means in this embodiment, the number of the microwave supplying means may be increased or reduced if desired.

Within the heating furnace main body 11, a heating oven 15 is set up to make works pass therethrough.

As has previously been described, this heating oven 15 is formed of microwave heat generating material such as ceramics, zirconia or silicon carbide mixed with powder of carbon or graphite or carbon carbon nanotube in the form of a long hollow body and laid on in alignment with a straight line connecting the inlet 11a and the outlet 11b of the heating furnace main body 11.

Specifically, this heating oven 15 is fixed and held by means of retaining pedestals 16 fixed to an inner bottom of the heating furnace main body 11 and partition walls 17 provided on an inner wall of the heating furnace main body 11 in the vicinity of the inlet 11a and the outlet 11b.

In this regard, the retaining pedestals 16 and the partition walls 17 are formed of thermal insulator having low microwave absorption ability.

The partition walls 17 not only function to support the heating oven 15 but also function to partition an inner space 11c of the heating furnace main body 11 from a space within a tunnel 15a of the heating oven 15 to prevent gas flowing through the tunnel 15a, i.e., inert gas necessary for heating treatment of the works 18 and smoke and gas generating in the course of heating treatment of the works 18 from leaking into the inner space 11c of the heating furnace main body 11.

As will be apparent from FIG. 2, the aforementioned oven 15 is a hollow body having a flattened shape in its cross-section taken in a direction crossing the direction in which the works 18 are transported and adapted to transport a plurality of the works 18 individually arranged side-by-side.

In this regard, the works 18 are rod-like, linear, strand-like or fibrous material fibers and it is possible to transport a plurality of the material fibers arranged individually side-by-side or a plurality of bundles each including a plurality of the individual works arranged side-by-side through the tunnel 15a of the heating oven 15.

In the heating system 10 constructed as has been described above, the microwave power radiated from the radiation window 13c into the inner space 11c of the heating furnace main body 11 is absorbed by the heating oven 15 made of the microwave heat generating material and, in consequence, the heating oven 15 generates heat and its temperature rises.

In this way, the works 18 supplied through the inlet 11a of the heating furnace main body 11, transported in the tunnel 15a of the heating oven 15 and discharged through the outlet 11b are heat-treated under radiation heat.

Though not illustrated, the heating furnace main body 11 and the inside of the tunnel 15a of the heating oven 15 are provided with temperature measurement means and control means adapted to control the microwave power output from the microwave oscillator 13a on the basis of a measurement value provided from the temperature measurement means. For embodiment, the microwave power output is controlled so that the temperature of the heating oven 15 may be elevated and maintained in accordance with the preset temperature profile with use of so-called PID control.

In this regard, of the PID control, P represents the proportional control, I represents the integrating control and D represents the differential control.

In one of specific embodiments, the measurement value obtained by the temperature measurement means is compared with the preset temperature profile and, as long as a temperature difference is significant, the proportional control is primarily actuated to control the microwave output and thereby to close such temperature gap as rapidly as possible. When the temperature difference becomes smaller than the first threshold value, the differential control is primarily actuated to control the microwave output so that the output may rapidly come close to the preset temperature profile. When the temperature difference falls within a range substantially corresponding to the preset temperature profile, the integrating control is primarily actuated to fine-adjust the microwave output and to achieve the temperature profile in accordance with the preset temperature profile.

While the method to control the temperature with use of the three-patterned PID control coefficients has been described above, the method of temperature control used for this invention is not limited to use of this three-patterned PID control coefficients.

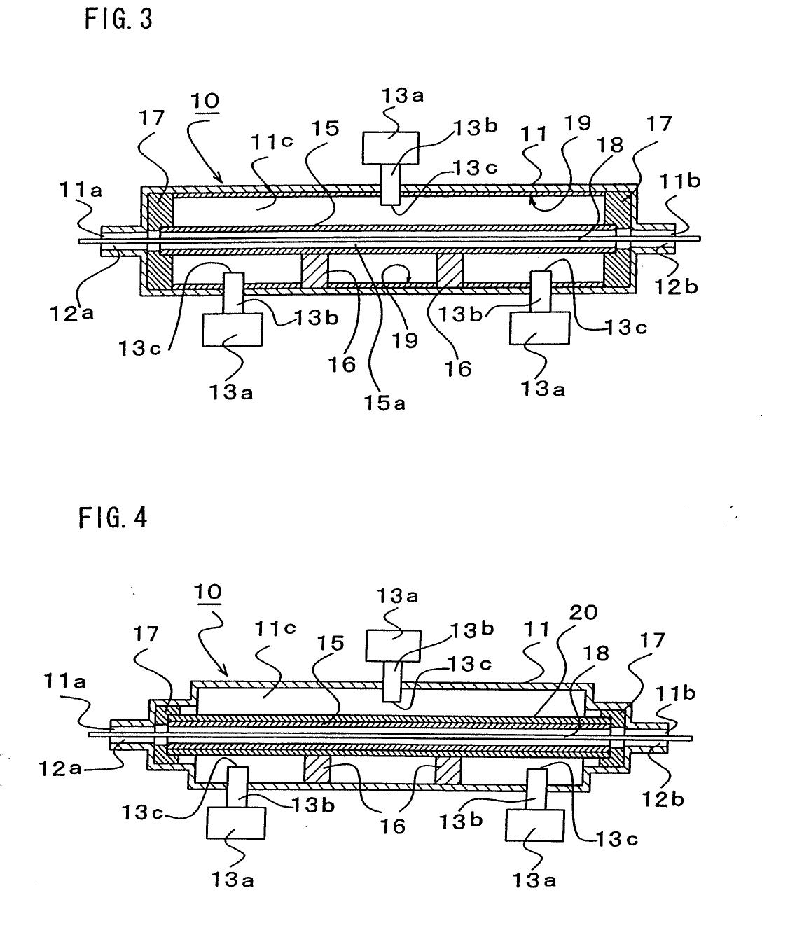

FIG. 3 illustrates one of modified embodiments of the heating system 10 according to this invention wherein the heating furnace main body 11 is provided on the inner surface thereof with a heat insulator 19.

In the case of this heating system 10, the heat insulator 19 blocks an amount of heat energy escaping from the outer surface of the heating oven 15 due to radiation to prevent such amount of heat energy from leaking out of the heating furnace main body and thereby to save the heat energy.

In this regard, the heat insulator may be provided on a partial area or an entire area of the inner surface of the heating furnace main body.

FIG. 4 illustrates one of modified embodiments of the heating system 10 according to this invention wherein the heating oven 15 is provided on the outer surface thereof with a heat insulator 20 having low microwave absorption ability.

In the case of this heating system 10, an amount of heat energy escaping from the outer surface of the heating oven 15 due to radiation is reduced and thereby to save the heat energy as the aforementioned modified embodiment is the case.

In this regard, the heat insulator may be provided on a partial area or an entire area of the outer surface of the heating oven 15.

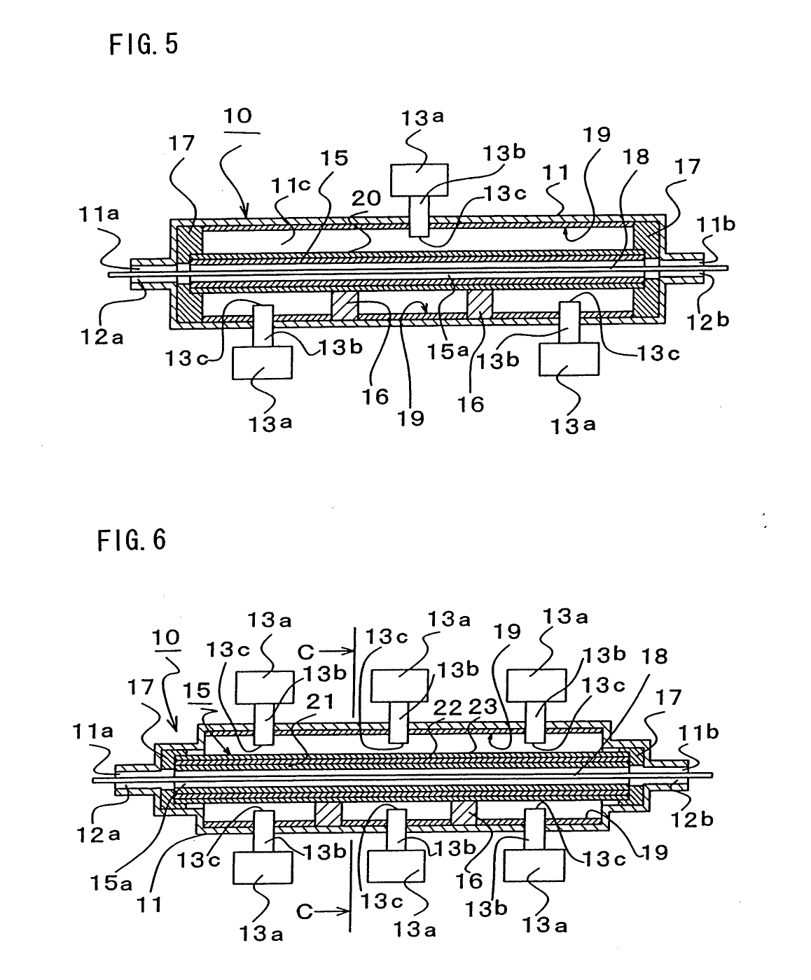

FIG. 5 illustrates one of modified embodiments of the heating system 10 wherein the heating furnace main body 11 is provided on the inner surface thereof with the heat insulator 19 and the heating oven 15 is provided on the outer surface thereof with the heat insulator 20 having low microwave absorption ability.

In the case of this heating system 10, the amount of heat energy escaping from the outer surface of the heating oven 15 due to radiation is reduced and, at the same time, the amount of heat energy is prevented from leaking out of the heating furnace main body 11. In this way, the heat energy can be further efficiently saved.

The heat insulator 19 may be provided on a partial area or an entire area of the inner surface of the heating furnace main body and the heat insulator 20 may be provided on a partial area or an entire area of the outer surface of the heating oven 15.

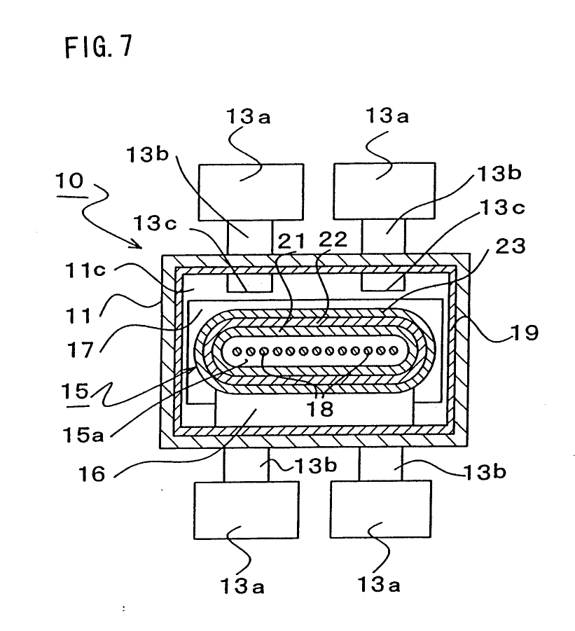

FIGS. 6 and 7 illustrate one of modified embodiments of the heating system according to this invention wherein the heating oven 15 is of three-layered construction including an inner layer 21 made of microwave shielding material, an intermediate layer 22 made of microwave heat generating material and an outer layer 23 made of heat insulator having low microwave absorption ability.

In the case of this heating system 10, the microwave power is reflected on the inner layer 21 made of the microwave shielding material and can not penetrate into the tunnel 15a of the heating oven 15.

Consequently, even when the work 18 is made of material highly susceptible to the influence of the microwave power, the product of high quality can be obtained by the heat treatment.

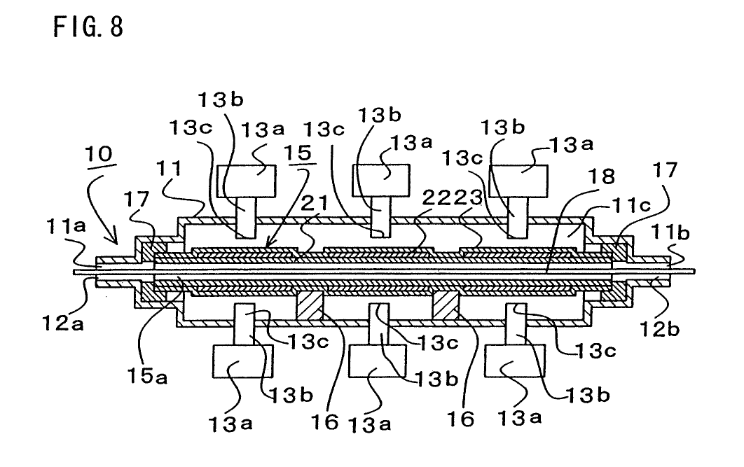

FIG. 8 illustrates one of modified embodiments of the heating system 10 according to the first embodiment wherein the heating oven 15 is of three-layered construction similar to the embodiment illustrated by FIGS. 6 and 7 but the intermediate layer 22 is intermittently formed.

As illustrated, the intermediate layer 22 made of microwave heat generating material may be selectively provided in the locations in which efficient and effective heat generation is required. In this modified embodiment, the intermediate layers 22 are provided in the vicinity of the respective radiation windows 13c.

It should be noted here that it is not essential to provide the outer layer 23 in this embodiment.

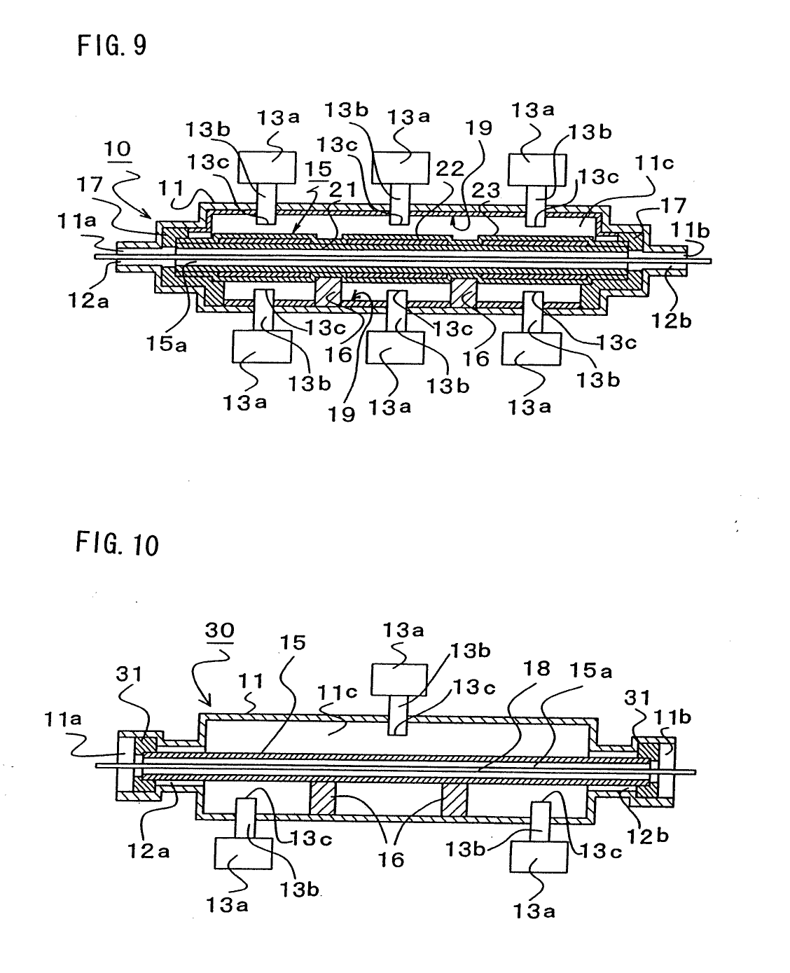

FIG. 9 illustrates one of modified embodiments of the first embodiment similar to the modified embodiment illustrated in FIG. 8 except that the heating furnace main body 11 is provided on the inner surface thereof with the heat insulator 19.

FIG. 10 is a sectional view of the heating system 30 according to a second embodiment of this invention taken in parallel to the direction in which the works are transported. The heating system 30 according to this embodiment is similar to the heating system 10 according to the first embodiment illustrated in FIG. 1 except that one end of the heating oven 15 is projected through the filtering zone toward the inlet 11a and supported by support means 31 made of heat insulating material provided within the inlet 11a, on one hand, and the other end of the heating oven 15 is projected through the filtering zone toward the outlet 11b and supported by support means 31 made of heat insulating material provided within the outlet 11b, on the other hand.

In the case of this heating system 30 constructed in this manner, the inner space 11c of the heating furnace main body 11 and the opposite end openings of the heating oven 15 are partitioned by the filtering zones and there is no possibility that the microwave power within the inner space 11c of the heating furnace main body 11 might work into the heating oven 15 through the opposite end openings thereof.

Consequentially, the works 17 being transported through the heating oven 15 are free from any direct influence of the microwave power whether the microwave absorption ability of the works are high or low and even when a plurality of works 18 are transported through the heating oven 15 to be heat-treated, all the works 18 can be uniformly heated to provide high quality products.

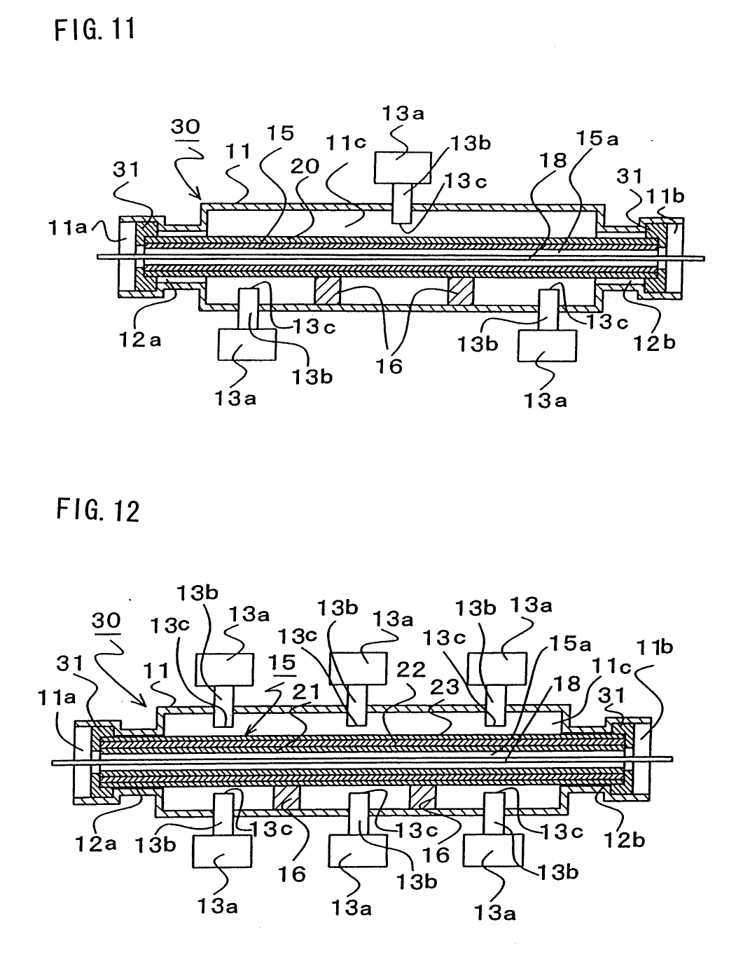

FIG. 11 illustrates the heating system 30 as one of modified embodiments of the second embodiment wherein the heating oven 15 is provided on the outer surface thereof with the heat insulator 20 having low microwave absorption ability as the heating system illustrated in FIG. 4 is the case.

FIG. 12 illustrates the heating system 30 as one of modified embodiments of the second embodiment provided with the heating oven 15 of three-layered construction including the inner layer 21 made of the microwave shielding material, the intermediate layer 22 made of the microwave heat generating material and the outer layer 23 made of the heat insulator material having low microwave absorption ability as the heating system illustrated in FIGS. 6 and 7 is the case.

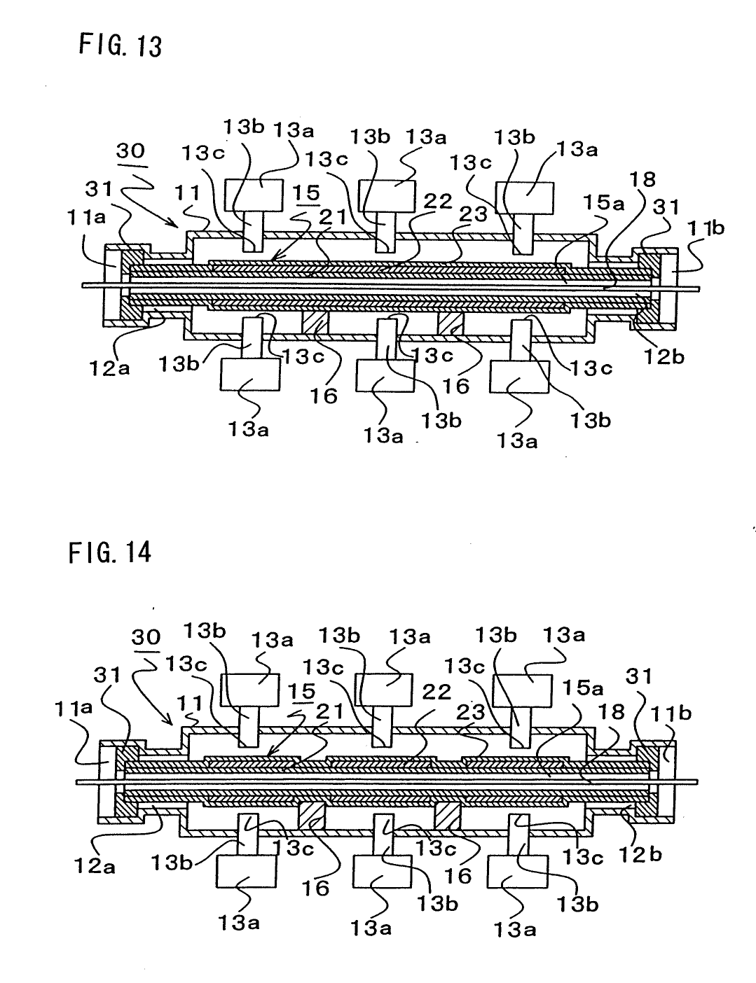

FIG. 13 illustrates the heating system 30 similar to that illustrated in FIG. 12 except that the heating oven 15 is partially provided with the intermediate layer 22 made of the microwave heat generating material.

FIG. 14 illustrates the heating system 30 as one of modified embodiments of the second embodiment provided with the heating oven 15 of three-layered construction as that illustrated in FIG. 12 is the case except that the intermediate layer 22 is intermittently provided.

In this regard, it is not essential for this embodiment to provide the outer layer 23 made of heat insulating material.

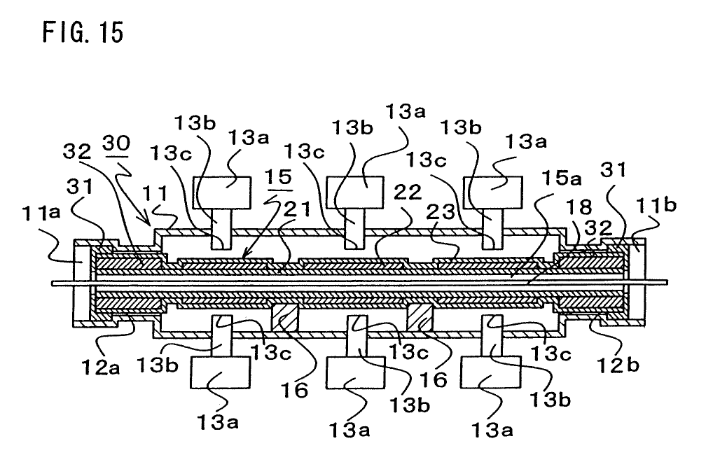

FIG. 15 illustrates the heating system 30 similar to that illustrated in FIG. 14 except that the respective filtering zones 12a, 12b are provided with microwave heat generating means 32 made of microwave absorptive material.

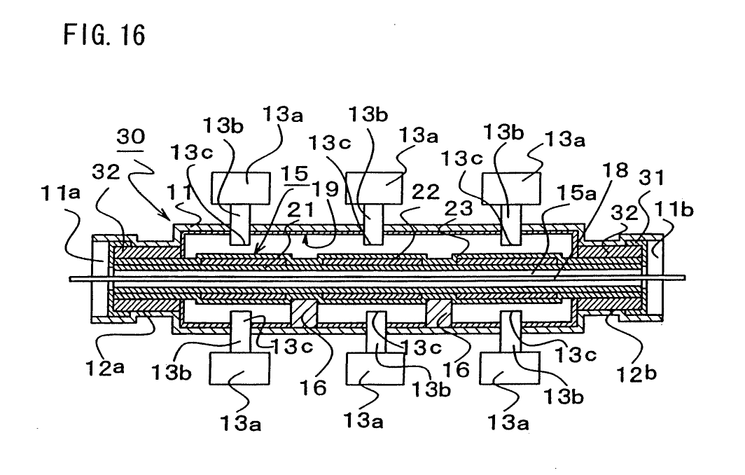

FIG. 16 illustrates the heating system 30 similar to that illustrated in FIG. 14 except that the filtering zones 12a, 12b are provided with the microwave heat generating means 32 made of microwave absorptive material and the heating furnace main body 11 is provided on the inner surface thereof with the heat insulator 19.

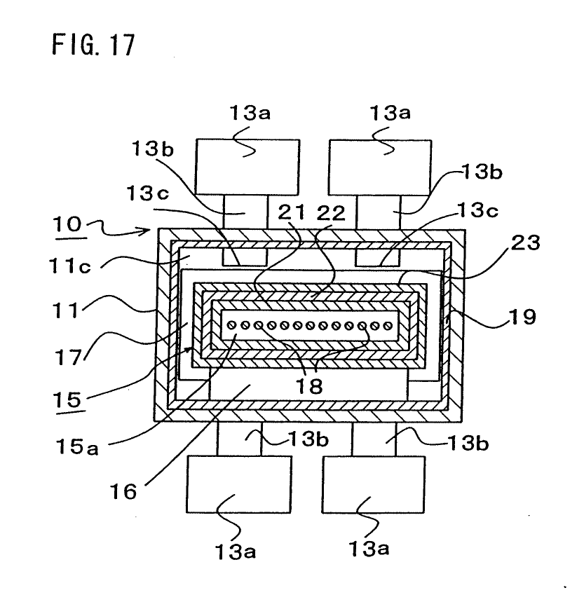

FIG. 17 illustrates the heating system similar to that illustrated in FIG. 6 or FIG. 12 wherein the heating oven 15 is of three-layered construction including the inner layer 21 formed of the microwave shielding material, the intermediate layer 22 formed of microwave heat generating material and the outer layer 23 formed of heat insulating material having low microwave absorption ability and the heating oven 15 has a rectangular cross-sectional shape as taken in a direction crossing the direction in which the works 18 are transported.

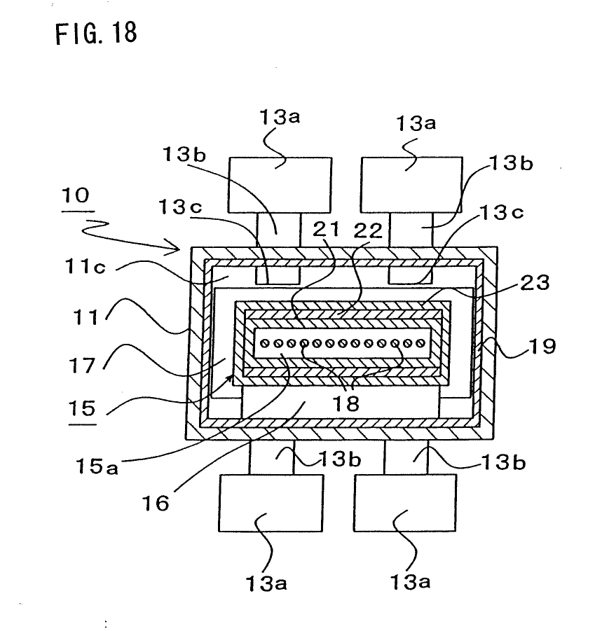

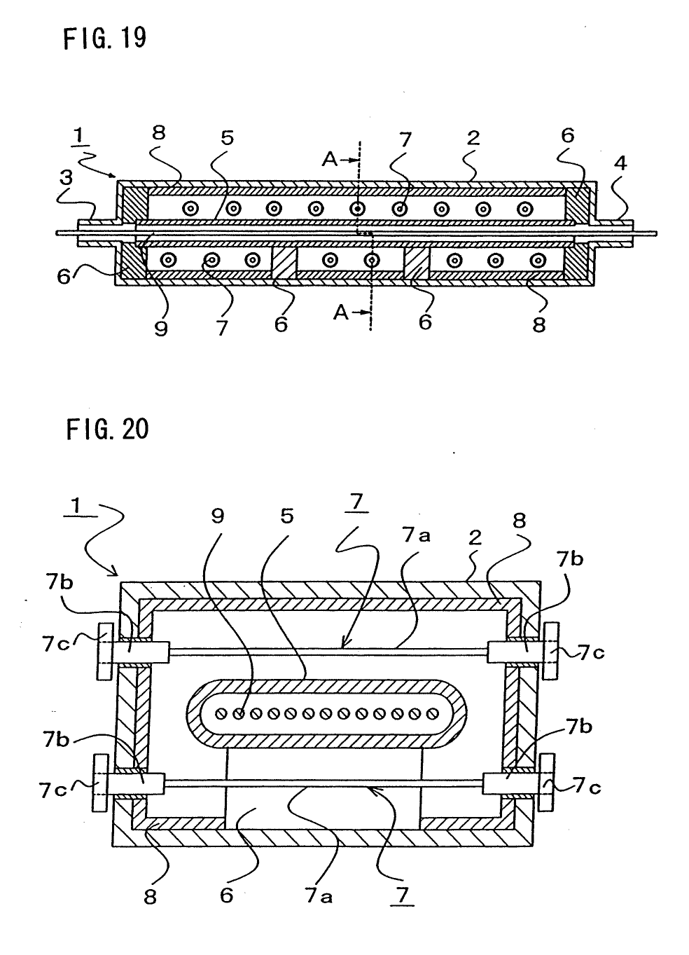

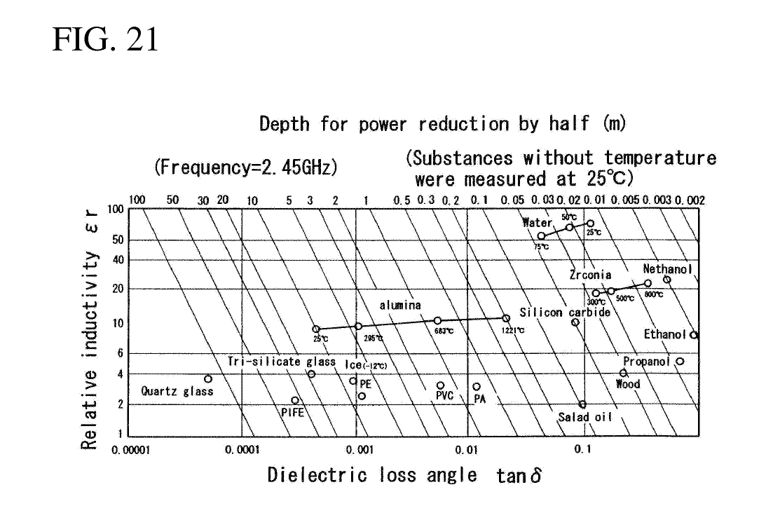

FIG. 18 illustrates the three-layered construction 15 similar to that illustrated in FIG. 17 except that the portions of the heating oven corresponding to upper and lower sides of the aforementioned rectangular cross-section are respectively of three-layered construction including the inner layer 21 formed of microwave shielding material, the intermediate layer 22 formed of microwave heat generating material and the outer layer 23 formed of heat insulating material having low microwave absorption ability, on one hand, and portions of the heating oven corresponding to right and left sides of the rectangular cross-section are respectively of two-layered construction including the outer layer 23 formed of heat insulating material having low microwave absorption ability, on the other hand.

What is claimed is:

1. A heating system with use of microwave characterized in that the system includes:
a heating furnace main body made of metallic material;
microwave supplying means adapted to supply the heating furnace main body with microwave power;
filtering zones respectively provided in the vicinity of an inlet at one side of the heating furnace main body and in the vicinity of an outlet at the other side of the heating furnace main body to prevent leak of the microwave power;
a heating oven formed of microwave heat generating material in a form of an oblong hollow body so as to extend linearly between the inlet and the outlet of the heating furnace main body; and
heat insulator having low microwave absorption ability adapted to separate off a space defined between an inner surface of the heating furnace main body and an outer surface of the heating oven from a space within the heating oven and adapted also to hold the heating oven;
wherein a work or works is or are supplied into the heating oven and discharged from the outlet to heat the work or works within the heating oven.

2. A heating system with use of microwave characterized in that the system includes:
a heating furnace main body made of metallic material;
microwave supplying means adapted to supply the heating furnace main body with microwave power;
filtering zones respectively provided in the vicinity of an inlet at one side of the heating furnace main body and in the vicinity of an outlet at the other side of the heating furnace main body to prevent leak of the microwave power;
a heating oven formed of microwave heat generating material in a form of an oblong hollow body so as to extend linearly between the inlet and the outlet of the heating furnace main body; and
heat insulator having low microwave absorption ability adapted to hold the heating oven;
wherein a work or works is or are supplied into the heating oven and discharged from the outlet to heat the work or works within the heating oven.

3. The heating system defined by claim 1 wherein the outer surface of the heating oven is partially or wholly covered with insulating material having low microwave absorption ability.

4. The heating system defined by claim 1 wherein the inner surface of the heating furnace main body is partially or wholly covered with insulating material.

5. The heating system defined by claim 1 wherein the heating oven is made of microwave heat generating material.

6. The heating system defined by claim 1 wherein the heating oven has its inner surface formed of microwave shielding material and its outer surface formed of microwave heat generating layer intermittently arranged in an axial direction of the heating oven.

7. The heating system defined by claim 1 wherein the heating oven is of three-layered construction including an inner layer made of microwave shielding material, an intermediate layer made of microwave heat generating material and an outer layer made of low microwave absorption ability.

8. The heating system defined by claim 1 wherein the heating oven is provided in a form of an oblong hollow body having a rectangular cross-sectional shape and portions of the heating oven corresponding to upper and lower sides of the aforementioned rectangular cross-section are respectively of three-layered construction including the inner layer formed of microwave shielding material, the intermediate layer formed of microwave heat generating material and the outer layer formed of heat insulating material having low microwave absorption ability, on one hand, and portions of the heating oven corresponding to right and left sides of the rectangular cross-section are respectively of two-layered construction including the outer layer formed of heat insulating material having low microwave absorption ability, on the other hand.

9. The heating system defined by claim 1 wherein the filtering zones are respectively provided with microwave heat generating means.

10. The heating system defined by claim 2 wherein the outer surface of the heating oven is partially or wholly covered with insulating material having low microwave absorption ability.

11. The heating system defined by claim 2 wherein the inner surface of the heating furnace main body is partially or wholly covered with insulating material.

12. The heating system defined by claim 2 wherein the heating oven is made of microwave heat generating material.

13. The heating system defined by claim 2 wherein the heating oven has its inner surface formed of microwave shielding material and its outer surface formed of microwave heat generating layer intermittently arranged in an axial direction of the heating oven.

14. The heating system defined by claim 2 wherein the heating oven is of three-layered construction including an inner layer made of microwave shielding material, an intermediate layer made of microwave heat generating material and an outer layer made of low microwave absorption ability.

15. The heating system defined by claim 2 wherein the heating oven is provided in a form of an oblong hollow body having a rectangular cross-sectional shape and portions of the heating oven corresponding to upper and lower sides of the aforementioned rectangular cross-section are respectively of three-layered construction including the inner layer formed of microwave shielding material, the intermediate layer formed of microwave heat generating material and the outer layer formed of heat insulating material having low microwave absorption ability, on one hand, and portions of the heating oven corresponding to right and left sides of the rectangular cross-section are respectively of two-layered construction including the outer layer formed of heat insulating material having low microwave absorption ability, on the other hand.

16. The heating system defined by claim 2 wherein the filtering zones are respectively provided with microwave heat generating means.
